(19) United States
(12) Patent Application Publication
(10) Pub. No.: US 2006/0178921 A1
(43) Pub. Date: Aug. 10, 2006

(54) Project management system and method therefor

(75) Inventors: Hsien-Pi Chuang, Hsinchu City (TW); David Lai, Jhonghe City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co., Ltd.

(21) Appl. No.: 11/051,384

(22) Filed: Feb. 4, 2005

(51) Int. Cl. G06F 9/46

(52) U.S. Cl. 705/8

(57) ABSTRACT

A project management system is disclosed. The project management system contains a schedule management subsystem and a progress management subsystem. The schedule management subsystem contains a schedule generator and a task assignment notification unit. The schedule generator generates a schedule table from project management information and task status information. The task assignment notification unit sends task assignment notices in accordance with the schedule table. The progress management subsystem, in communication with the schedule management subsystem, contains a task deadline controller and a deadline notification unit. The task deadline controller establishes a deadline control table in accordance with the task duration data. The deadline notification unit sends a deadline notice in accordance with the task deadline control table.

### BACKGROUND OF THE INVENTION

1. Field of the Invention

The present invention relates to project management system and particularly to a project management system capable of creating, tracking, and reporting data objects in project scheduling tables.

2. Description of the Prior Art

FIG. 1 is a schematic view of a conventional operation of project management. As shown in FIG. 1, using conventional tools, a project manager 110 sets up a schedule table 101 manually, assigns jobs to an operator 113 in accordance with the schedule table 101, orally or by written messages. The operator 113 keeps an execution status record 103 of the assigned task. The project manager 110 records progress for a particular job, updates the schedule table 101, and submits a progress report 105 to a manager 115. This manual process is not only time consuming but imprecise. The error probability and the time spent increase exponentially with complexity of technology.

Hence, there is a need for a project management system better addressing the shortcomings of the conventional system.

### SUMMARY OF THE INVENTION

Accordingly, an object of the invention is to provide a project management system capable of storing, analyzing, and reporting data objects in project scheduling tables; enabling lower technology transfer costs; and reducing errors from manual technology transfer.

In one embodiment, the project management system includes a schedule management subsystem and a progress management subsystem. The schedule management subsystem includes a schedule generator and a task assignment notification unit. The schedule generator generates a schedule table from project management information and task status information. The task assignment notification unit sends task assignment notices in accordance with the schedule table. The progress management subsystem, linked to the schedule management subsystem, includes a deadline controller and a deadline notification unit. The deadline controller establishes a deadline control table in accordance with the schedule table. The deadline notification unit issues deadline notices according to the deadline control table.

Another object of the present invention is to provide a project management method to implement the project management system. The method of one embodiment comprises the following steps. First, project management information and task status information are provided. Second, a schedule table is generated from project management information and the task status information. The schedule table includes a task item and corresponding task operator data, task duration data, and task progress data. Next, a task assignment notice is sent in accordance with the task operator data, and a deadline control table is established in accordance with the task duration data. In addition, a deadline notice is sent in accordance with the deadline control table.

In yet another embodiment the above-mentioned method may take the form of program code embodied in tangible media. When the program code is loaded into and executed by a machine, the machine becomes an apparatus for practicing the invention.

A detailed description is given in the following embodiments with reference to the accompanying drawings.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a schematic view of the operation of project management as referenced in the prior art;

FIG. 2 is a schematic view of one embodiment of a project management system in accordance with the present invention;

FIG. 3 is a schedule table in accordance with the project management system of FIG. 2;

FIG. 4 is a deadline control table in accordance with the project management system of FIG. 2;

FIG. 5 is a comparison report in accordance with the project management system of FIG. 2;

FIG. 6 is a task item generation in accordance with the project management system of FIG. 2;

FIGS. 7A and 7B are reports generated in accordance with the project management system of FIG. 2; and

FIG. 8 is a diagram of one embodiment of a storage medium for storing a computer program providing the project management method according to the present invention.

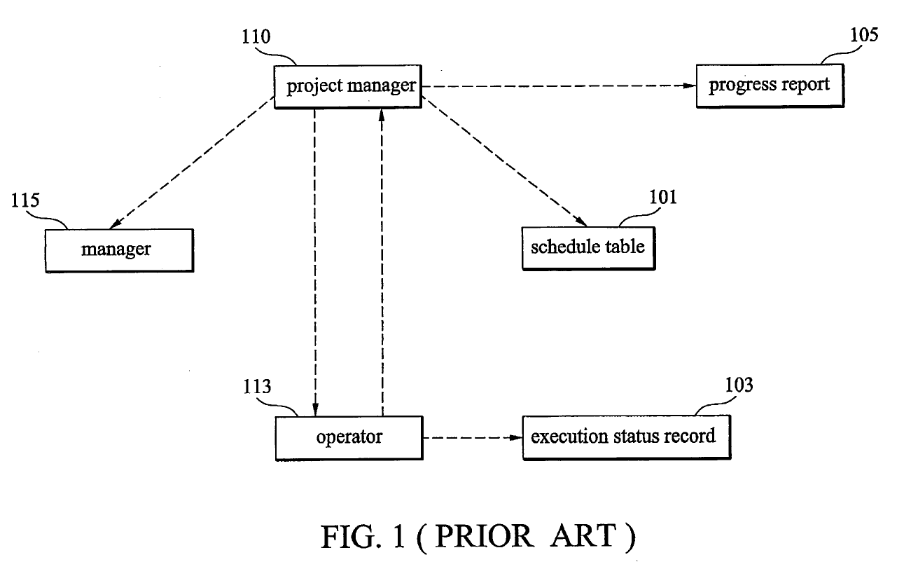

### DETAILED DESCRIPTION OF THE INVENTION

According to the embodiments detailed herein, the invention is implemented in a wafer-manufacturing environment for managing project information pertaining to technology transfer with reference to the accompanying drawings.

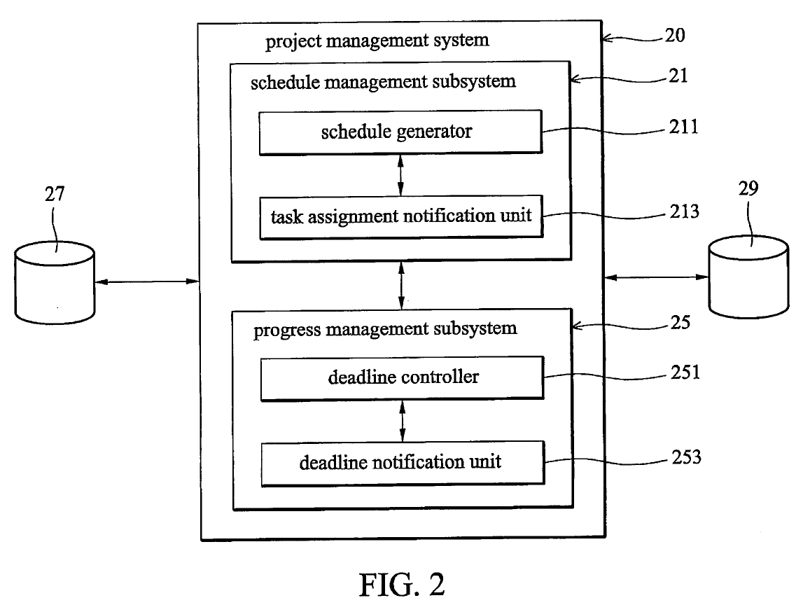

FIG. 2 is a schematic view of the project management system in accordance with the invention. A project management system 20 enables project planning and task scheduling, resource management, and progress reporting.

The project management system 20 communicates with a management workstation 29 and a resource workstation 27, accessed by project managers and system resources, respectively. The project management system 20 includes a schedule management subsystem 21 and a progress management subsystem 25.

The schedule management subsystem 21 includes a schedule generator 211 and a task assignment notification unit 213. The schedule generator 211 generates a schedule table from project management information and task status information. The task assignment notification unit 213 sends task assignment notices in accordance with the schedule table.

The progress management subsystem 25, linked to the schedule management subsystem 21, comprises a deadline controller 251 and a deadline notification unit 253. The deadline controller 251 establishes a deadline control table in accordance with the task duration data. The deadline notification unit 253 sends a deadline notice in accordance with the deadline control table.

In the case of technology transfer in a wafer-manufacturing environment, a Process Release Standard (PRS) serves as the center of technology transfer process. The transferred technology has all its details recorded in accordance with the PRS. A technology transfer project, involving personnel from various departments, contains numerous tasks to transfer details of technology implementation.

During the planning stage of the project, project management information is input into the project management system 20 via the management workstation 29. Project management information includes primary information and secondary information. The primary information contains information essential for creating the project schedule, such as project items, project tasks, and system resources, wherein the system resources consist essentially of human resources. The secondary information contains category information of the project not essential for creating the project schedule but useful for performing project management and reporting functions. The project management system 20 uses project management information to create a project schedule. Once a project schedule is created, task status information is input into the project management system 20 via the resource workstation 27.

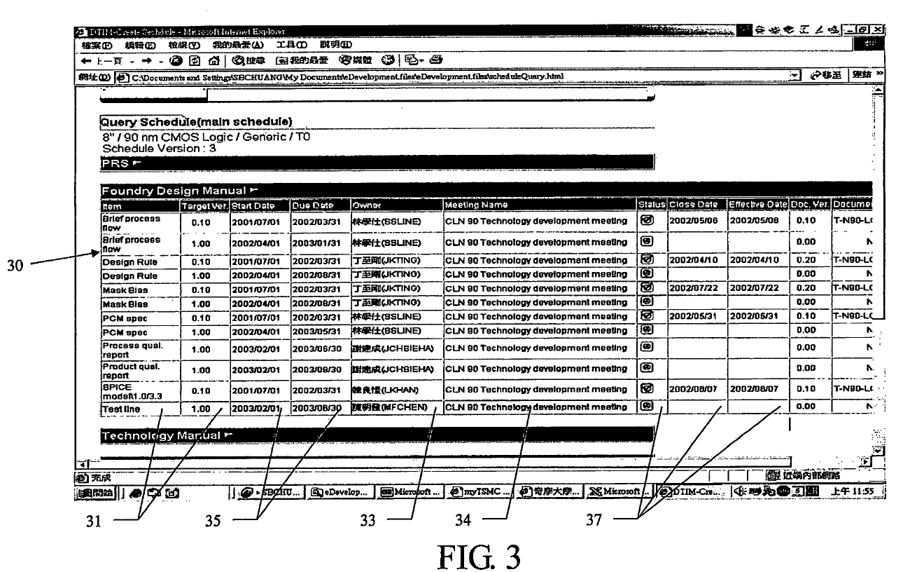

The schedule generator 211 generates a project schedule from project management information and the task status information. As shown in FIG. 3, the schedule table 30 includes a task item field 31 and corresponding operator data field 33, duration data field 35, progress data field 37.

As mentioned above, the technology transfer project involves personnel from various departments; therefore, a trans-department meeting is established to serve as referential resource, the results of which are recorded in a referential field 34 of schedule table 30.

The contents of the task item field 31, the operator data field 33, the duration data field 35, the progress data field 37, and the referential field 34 are based on the primary information of project management information.

Each task in the technology transfer project corresponds to a particular part of the transferred technology. The properties of the technology information transferred in each task serve as category information thereof. In the wafer-manufacturing environment, the manufacturing module and manufacturing layer to which the transferred technology information applies are important category information of a technology transfer task. The category information is part of the secondary information.

After the project schedule is established, the task assignment notification unit 213 sends task assignment notices in accordance with the information in the operator data field 33.

The operator receiving the task assignment notices maintains task status information at the resource workstation 27. The project management system 20 retrieves the task status information form the resource workstation 27 periodically and updates the record in the progress data field 37 accordingly.

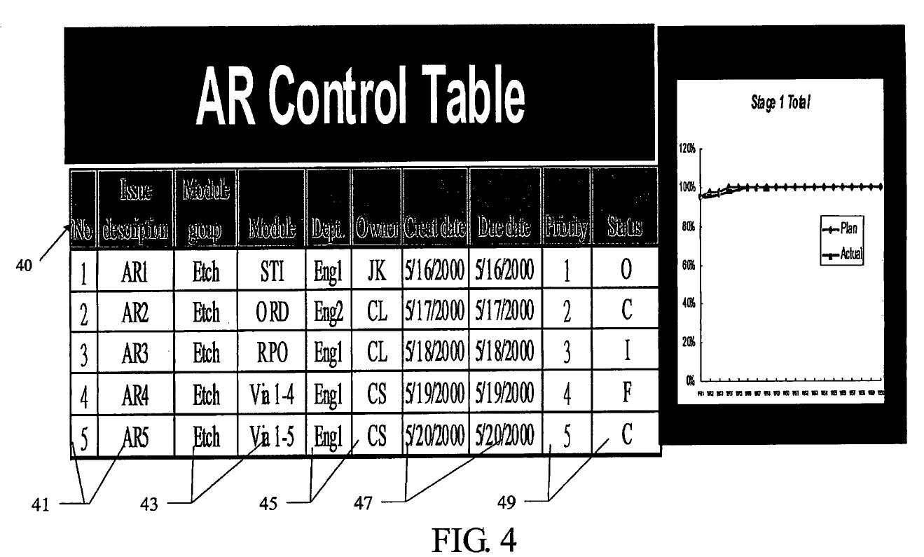

After the project schedule is established, the deadline controller 251 establishes a deadline control table in accordance with the information in the duration data field 35. As shown in FIG. 4, a deadline control table 40 comprises a task item field 41, an operator data field 45, a duration data field 47, a progress data field 49, and at least one data field for category information, such as a module data field 43. The format and content of the deadline control table vary in different situations.

Based on the deadline control table 40, the deadline notification unit 253 detects overdue task items by comparing the information in the duration data field 47 and the progress data field 49, and sends deadline notices to the operators corresponding to the overdue task items. The deadline notice is given by way of e-mail.

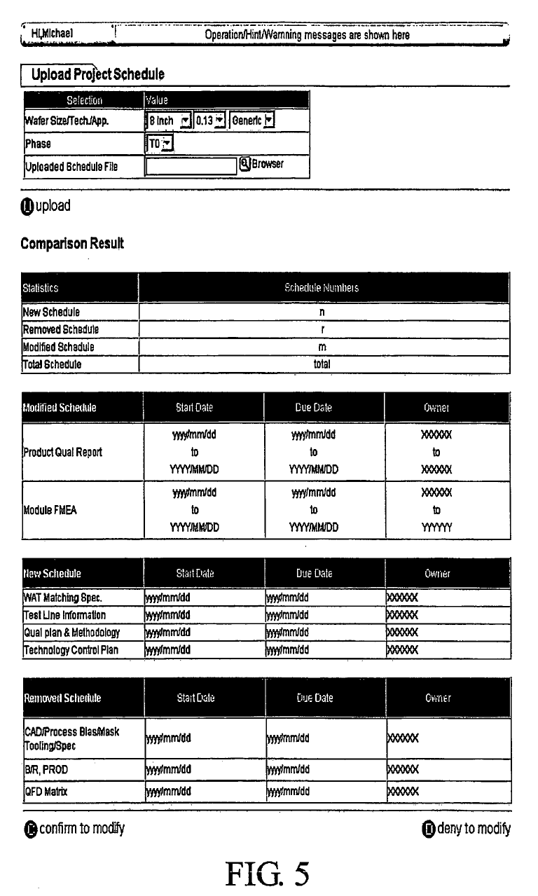

As mentioned above, the technology transfer project involves numerous personnel and technology detail. Thus, the project schedule is subject to changes, and different versions of a particular project schedule can exist. The schedule management subsystem 21 further comprises a schedule comparator for comparing different versions and generating a comparison report thereof. The comparison report, illustrated in FIG. 5, contains a list of differences between different schedule versions.

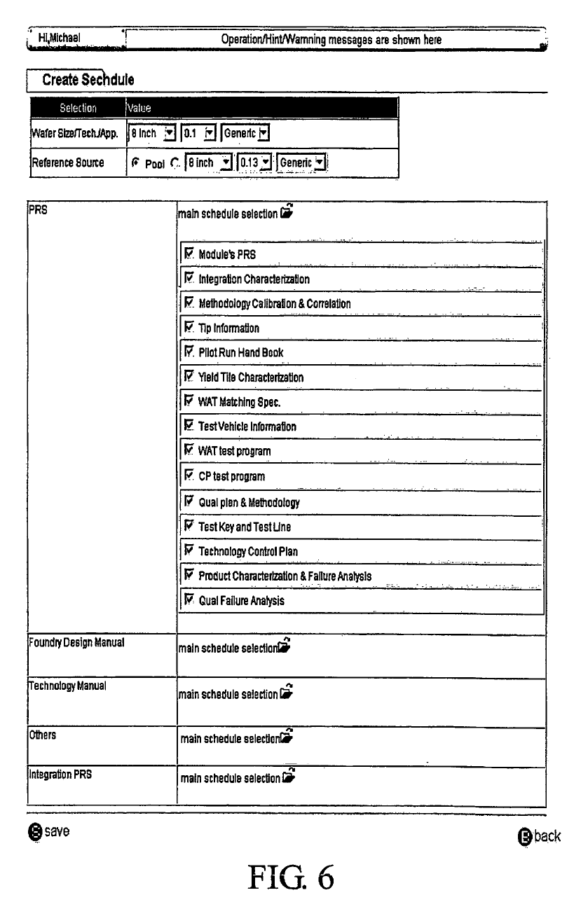

As mentioned above, the PRS of the transferred technology is the center of the transfer project. Therefore, transfer projects for different technologies, though involving different personnel and details, may have similar task arrangements. The schedule management subsystem 21 further comprises an item generator to generate task items in a schedule by incorporating manufacturing information into a blank schedule. FIG. 6 shows a task item generation as described above.

The schedule management subsystem 21 further comprises a report generator to generate task reports on demand. The report generator retrieves data from the schedule table to generate a task report in response to a predefined or input report demand.

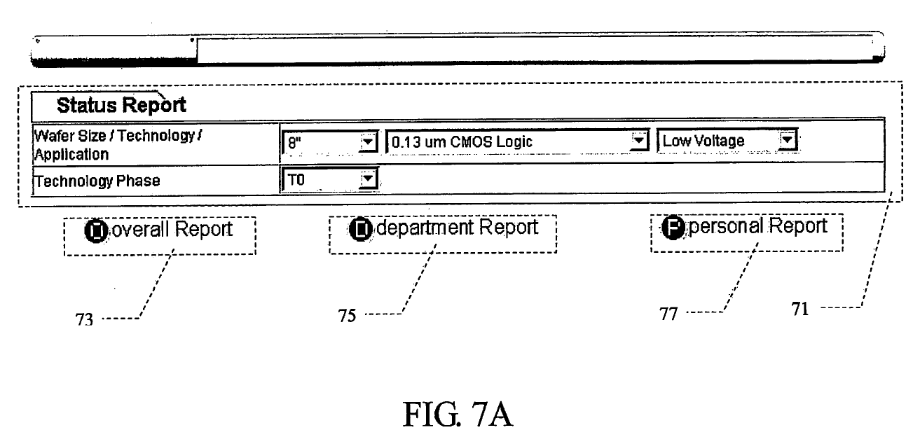

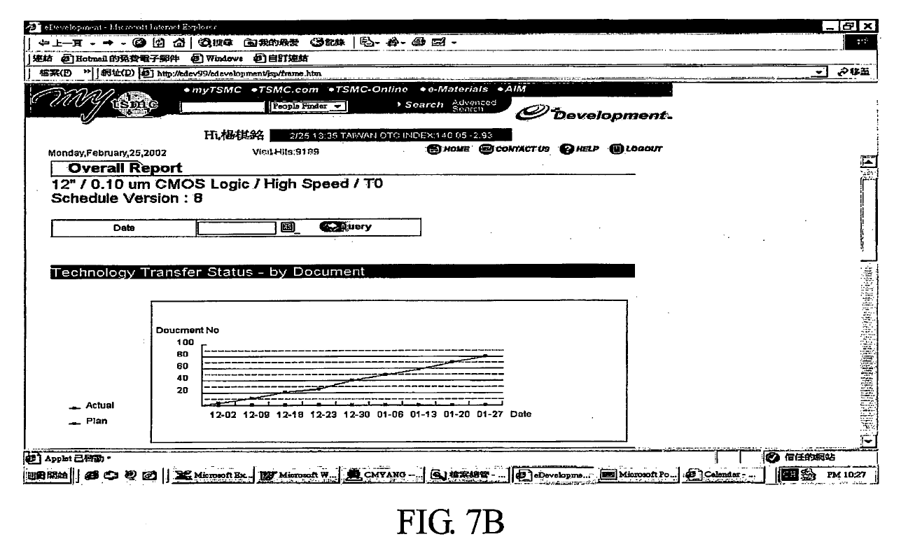

FIGS. 7A and 7B show reports generated by the schedule management subsystem. As shown by block 71 in FIG. 7A, a user selects the item as the subject of a report. Next, a report type is selected by one of the three buttons illustrated in FIG. 7A, overall report button 73, department report button 75, or personal report button 77. FIG. 7B shows an overall report.

The present invention provides a project management method implemented in the project management system mentioned above.

First, project management information and task status information are provided.

Second, a schedule table is generated according to project management information and the task status information. The schedule table includes a task item and corresponding task operator data, task duration data, and task progress data.

Then, a task assignment notice is sent in accordance with the task operator data.

Then, a deadline control table is established in accordance with the task duration data. In addition, a deadline notice is sent in accordance with the deadline control table.

The method of the present invention, or certain aspects or portions thereof, may take the form of program code (i.e. instructions) embodied in tangible media, such as floppy diskettes, CD-ROMS, hard drives, or any other machine-readable storage medium. When the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission. When the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

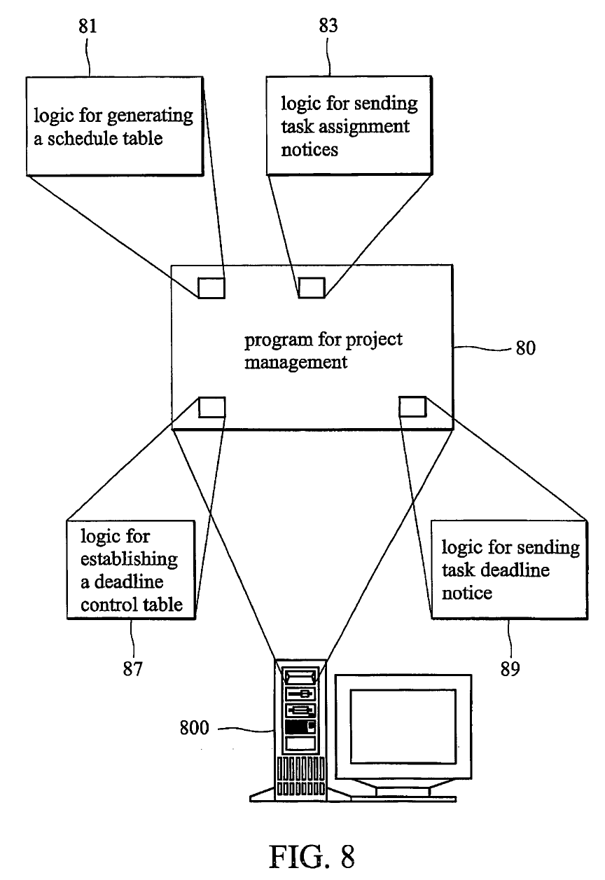

FIG. 8 is a diagram of a storage medium for storing a computer program providing the schedule management method according to the present invention. The computer program product comprises computer usable storage media having computer readable program code 80 embodied in the medium. The computer readable program code 80 comprises computer readable program code 81 for generating a schedule table, computer readable program code 83 for sending task assignment notices, computer readable program code 87 for establishing a deadline control table, and computer readable program code 89 for sending task deadline notices.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation to encompass all such modifications and similar arrangements.

What is claimed is:

1. A project management system, comprising:
a schedule management subsystem, the schedule management subsystem comprising:
a schedule generator for generating a schedule table from a project management information and a task status information, wherein the schedule table includes a task item and corresponding task operator data, task duration data, and task progress data; and
a task assignment notification unit for sending task assignment notices in accordance with the task operator data; and
a progress management subsystem comprising:
a deadline controller for establishing a deadline control table in accordance with the task duration data; and
a deadline notification unit for sending deadline notice in accordance with the deadline control table.

2. The project management system as claimed in claim 1, wherein the schedule table comprises category information pertaining to a manufacturing module of transferred technology of the task item.

3. The project management system as claimed in claim 1, wherein the schedule table comprises category information pertaining to the manufacturing layer of the transferred technology of the task item.

4. The project management system as claimed in claim 1, wherein the schedule table comprises category information pertaining to referential resources of the task item.

5. The project management system as claimed in claim 1, wherein the schedule management subsystem further comprises a schedule comparator for comparing a first schedule and a second schedule and extracting differences therebetween.

6. The project management system as claimed in claim 1, wherein the schedule management subsystem further comprises a report generator for generating a report on demand in accordance with the schedule table.

7. The project management system as claimed in claim 1, wherein the schedule management subsystem further comprises a task item generator for generating a task item from manufacturing processing data.

8. A project management method, comprising:
providing project management information and task status information;
generating a schedule table from project management information and the task status information, wherein the schedule table comprises task items and corresponding task operator data, task duration data, and task progress data;
sending a task assignment notice in accordance with the task operator data;
establishing a deadline control table in accordance with the task duration data; and
sending a deadline notice in accordance with the deadline control table.

9. The project management method as claimed in claim 8, further comprising establishing a field in the schedule table for category information pertaining to manufacturing modules of the transferred technology of the task item.

10. The project management method as claimed in claim 8, further comprising establishing a field in the schedule table for category information pertaining to a manufacturing layer of the transferred technology of the task item.

11. The project management method as claimed in claim 8, further comprising establishing a field in the schedule table for category information pertaining to referential resources of the task item.

12. The project management method as claimed in claim 8, further comprising comparing a first schedule and a second schedule and extracting differences therebetween.

13. The project management method as claimed in claim 8, further comprising generating a report on demand in accordance with the schedule table.

14. A method of schedule management comprising:
receiving project management information and task status information;
generating a schedule table from project management information and the task status information, wherein the schedule table includes a task item and corresponding task operator data, task duration data, and task progress data;
sending task assignment notices in accordance with the task operator data;
establishing a deadline control table in accordance with the task duration data; and
sending deadline notice in accordance with the deadline control table.

15. The method of claim 14, further comprising establishing a field in the schedule table for category information pertaining to manufacturing modules of the transferred technology of the task item.

16. The method of claim 14, further comprising establishing a field in the schedule table for category information pertaining to manufacturing layer of the transferred technology of the task item.

17. The method of claim 14, further comprising establishing a field in the schedule table for category information pertaining to referential resources of the task item.

18. The method of claim 14, further comprising comparing a first schedule and a second schedule and extracting differences therebetween.

19. The method of claim 14, further comprising generating a report on demand in accordance with the schedule table.
